(19) United States
(12) Patent Application Publication
(10) Pub. No.: US 2006/0228047 A1
(43) Pub. Date: Oct. 12, 2006

(54) Image processing apparatus and method, recording medium and program

(75) Inventors: Takeshi Harada, Tokyo (JP); Tatsuhito Tabuchi, Chiba (JP); Yuji Saitou, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/388,020

(22) Filed: Mar. 24, 2006

(30) Foreign Application Priority Data
Apr. 6, 2005 (JP) 2005-110045

(51) Int. Cl. G06K 9/32

(52) U.S. Cl. 382/298

(57) ABSTRACT

An image processing apparatus and method is disclosed wherein a plurality of images having different aspect ratios can be displayed with minimized distortion on the same display screen. An image processing apparatus records a thumbnail image with an aspect ratio of 4:3. When a thumbnail image whose aspect ratio is corrected from 16:9 to 4:3 is to be displayed on a display screen whose aspect ratio is 4:3, the thumbnail image is reduced so as to have a heightwise dimension reduced to ¾. On the other hand, when a thumbnail image whose aspect ratio remains 4:3 and is not corrected is to be displayed on a display screen whose aspect ratio is 16:9, the thumbnail image is reduced so as to have a widthwise dimension reduced to ¾. The present invention can be applied to a digital video camera.

### CROSS REFERENCES TO RELATED APPLICATIONS

The present invention contains subject matter related to Japanese Patent Application JP 2005-110045 filed in the Japanese Patent Office on Apr. 6, 2005, the entire contents of which being incorporated herein by reference.

### BACKGROUND OF THE INVENTION

This invention relates to an image processing apparatus and method, a recording medium and a program, and more particularly to an image processing apparatus and method, a recording medium and a program wherein an image having small distortion can be displayed.

A television receiver (hereinafter referred to as TV receiver) in related art wherein the display screen has an aspect ratio 4:3 has been used popularly. However, in recent years, a TV receiver wherein the display screen has another aspect ratio of 16:9 and is called wide screen has been and is being popularized.

Also in the field of digital video cameras, a digital video camera has been and is being popularized which can record and reproduce not only an image whose aspect ratio is 4:3 but also an image whose aspect ratio is 16:9.

In such a digital video camera as just described, images whose aspect ratio is 4:3 and images whose aspect ratio is 16:9 are recorded in a mixed fashion on or in one recording medium such as a DVD (Digital Versatile Disc).

A digital video camera has been proposed wherein, where a plurality of images are recorded, thumbnail images are displayed as a list of the recorded images on a viewfinder or a display apparatus. A digital video camera of the type described is disclosed, for example, in Japanese Patent Laid-open No. 2000-41209.

### SUMMARY OF THE INVENTION

However, if the aspect ratios of a display screen and a thumbnail image do not coincide with each other, then the displayed image is distorted.

It is desirable to provide an image processing apparatus and method, a recording medium and a program wherein a plurality of images having different aspect ratios can be displayed with minimized distortion on the same display screen.

According to an embodiment of the present invention, there is provided an image processing apparatus including determining means for determining a relationship between a first aspect ratio which is an aspect ratio of a source image of a thumbnail image and a second aspect ratio which is an aspect ratio of a display screen on which the thumbnail image is to be displayed, reduction means for reducing, where the first and second aspect ratios are different from each other, the height or the width of the thumbnail image, and outputting means for outputting the thumbnail image of the reduced height or width.

According to another embodiment of the present invention, there is provided an image processing method for an image processing apparatus, including the steps of determining a relationship between a first aspect ratio which is an aspect ratio of a source image of a thumbnail image and a second aspect ratio which is an aspect ratio of a display screen on which the thumbnail image is to be displayed, reducing, where the first and second aspect ratios are different from each other, the height or the width of the thumbnail image, and outputting the thumbnail image of the reduced height or width.

According to a further embodiment of the present invention, there is provided a recording medium on or in which a computer-readable program for image processing for an image processing apparatus is recorded, the program including the steps of determining a relationship between a first aspect ratio which is an aspect ratio of a source image of a thumbnail image and a second aspect ratio which is an aspect ratio of a display screen on which the thumbnail image is to be displayed, reducing, where the first and second aspect ratios are different from each other, the height or the width of the thumbnail image, and outputting the thumbnail image of the reduced height or width.

According to a further embodiment of the present invention, there is provided a program for causing a computer of an image processing apparatus to execute image processing, the program including the steps of determining a relationship between a first aspect ratio which is an aspect ratio of a source image of a thumbnail image and a second aspect ratio which is an aspect ratio of a display screen on which the thumbnail image is to be displayed, reducing, where the first and second aspect ratios are different from each other, the height or the width of the thumbnail image, and outputting the thumbnail image of the reduced height or width.

According to a still further embodiment of the present invention, there is provided an image processing apparatus including a determining section for determining a relationship between a first aspect ratio which is an aspect ratio of a source image of a thumbnail image and a second aspect ratio which is an aspect ratio of a display screen on which the thumbnail image is to be displayed, a reduction section for reducing, where the first and second aspect ratios are different from each other, the height or the width of the thumbnail image, and an outputting section for outputting the thumbnail image of the reduced height or width.

In the image processing apparatus and method, recording medium and program, a relationship between a first aspect ratio which is an aspect ratio of a source image of a thumbnail image and a second aspect ratio which is an aspect ratio of a display screen on which the thumbnail image is to be displayed is determined. Then, if the first and second aspect ratios are different from each other, then the height or the width of the thumbnail image is reduced, and the thumbnail image of the reduced height or width is outputted.

Therefore, with the image processing apparatus and method, recording medium and program, an image can be displayed. Particularly, a plurality of images having different aspect ratios can be displayed with minimized distortion on the same display screen.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a perspective view showing an example of a configuration of a display control system to which the present invention is applied;

FIG. 2 is a block diagram showing an example of an internal configuration of a digital video camera shown in FIG. 1;

FIG. 3 is a view illustrating the image size of a thumbnail image of a still picture;

FIG. 4 is a view illustrating a thumbnail image whose aspect ratio is 16:9;

FIG. 5 is a block diagram showing an example of a functional configuration of an image processing program to which the present invention is applied;

FIG. 6 is a flow chart illustrating an aspect ratio detection process executed by the digital video camera;

FIG. 7 is a flow chart illustrating an index image drawing process executed by the digital video camera;

FIG. 8 is a view illustrating an index image on which drawing regions are disposed;

FIG. 9 is a view illustrating index image data corresponding to the index image;

FIG. 10 is a view illustrating thumbnail images drawn in the index image;

FIG. 11 is a view illustrating the index image in which drawing regions are disposed;

FIG. 12 is a view illustrating the index image data corresponding to the index image;

FIG. 13 is a view illustrating thumbnail images drawn on the index image;

FIG. 14 is a view illustrating a thumbnail image which is distorted in a state elongated in a widthwise direction;

FIG. 15 is a flow chart illustrating another example of the index image drawing process; and

FIG. 16 is a block diagram showing an example of a configuration of a personal computer.

### DETAILED DESCRIPTION OF THE PREFERRED EMBODIMENTS

Before a preferred embodiment of the present invention is described in detail, a corresponding relationship between several features recited in the accompanying claims and particular elements of the preferred embodiment described below is described. The description, however, is merely for the confirmation that the particular elements which support the invention as recited in the claims are disclosed in the description of the embodiment of the present invention. Accordingly, even if some particular element which is recited in description of the embodiment is not recited as one of the features in the following description, this does not signify that the particular element does not correspond to the feature. On the contrary, even if some particular element is recited as an element corresponding to one of the features, this does not signify that the element does not correspond to any other feature than the element.

Further, the following description does not signify that the prevent invention corresponding to particular elements described in the embodiment of the present invention is all described in the claims. In other words, the following description does not deny the presence of an invention which corresponds to a particular element described in the description of the embodiment of the present invention but is not recited in the claims, that is, the description does not deny the presence of an invention which may be filed for patent in a divisional patent application or may be additionally included into the present patent application as a result of later amendment to the claims.

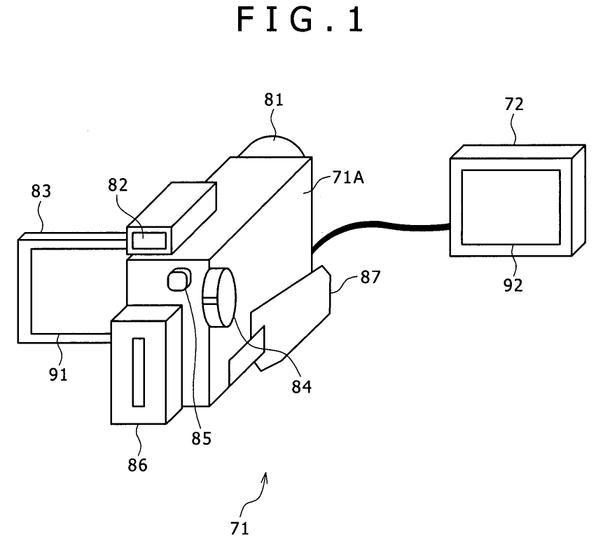

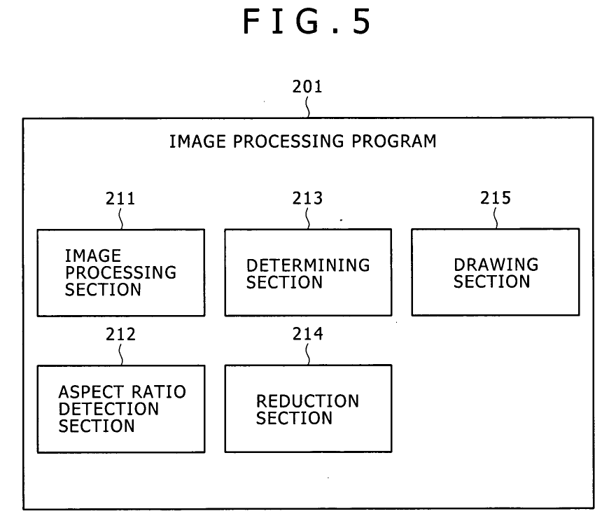

An image processing apparatus (for example, a digital video camera 71 in FIG. 1) according to an embodiment of the present invention includes determining means (for example, a determining section 213 in FIG. 5) for determining a relationship between a first aspect ratio which is an aspect ratio of a source image of a thumbnail image and a second aspect ratio which is an aspect ratio of a display screen (for example, a display screen 92 in FIG. 1) on which the thumbnail image is to be displayed, reduction means (for example, a reduction section 214 in FIG. 5) for reducing, where the first and second aspect ratios are different from each other, the height or the width of the thumbnail image, and outputting means (for example, a drawing section 215 in FIG. 5) for outputting the thumbnail image of the reduced height or width.

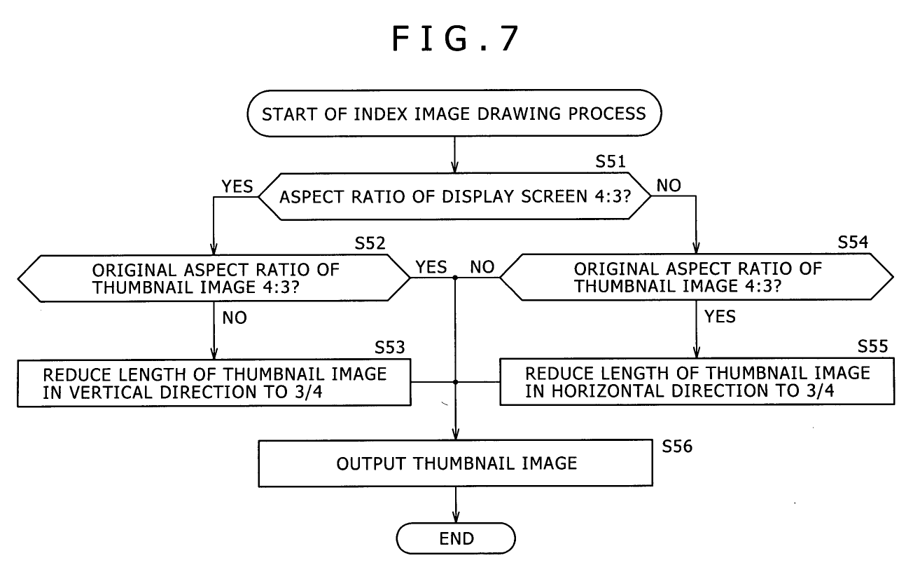

The image processing apparatus according to an embodiment of the present invention is configured such that, where the first aspect ratio is 16:9 and the second aspect ratio is 4:3, the reduction section reduces the height of the thumbnail image to ¾ (for example, a process at step S53 in FIG. 7).

The image processing apparatus according to an embodiment of the present invention is configured such that, where the first aspect ratio is 4:3 and the second aspect ratio is 16:9, the reduction section reduces the width of the thumbnail image to ¾ (for example, a process at step S55 in FIG. 7).

An image processing method according to an embodiment of the present invention is an image processing method for an image processing apparatus (for example, a digital video camera 71 in FIG. 1), which includes a determining step (for example, steps S51, S52 and S54 in FIG. 7) of determining a relationship between a first aspect ratio which is an aspect ratio of a source image of a thumbnail image and a second aspect ratio which is an aspect ratio of a display screen on which the thumbnail image is to be displayed, a reduction step (for example, steps S53 and S55 in FIG. 7) of reducing, where the first and second aspect ratios are different from each other, the height or the width of the thumbnail image, and an outputting step (for example, a step S56 in FIG. 7) of outputting the thumbnail image of the reduced height or width.

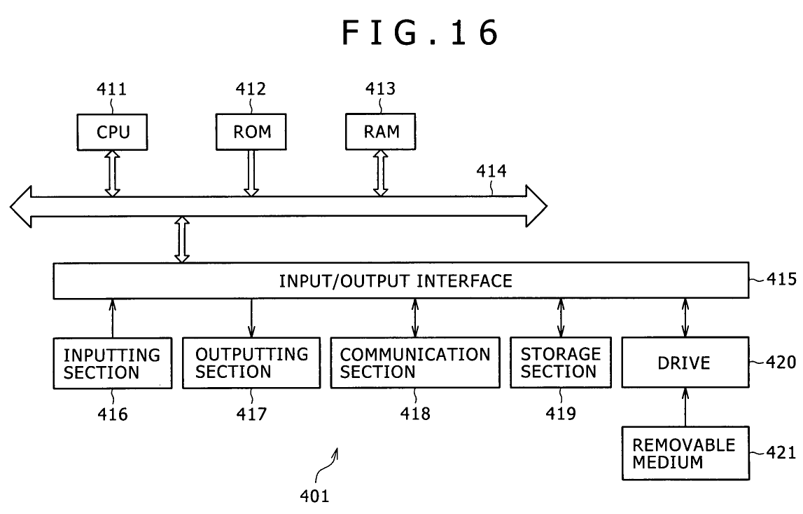

A program recorded on or in a recording medium (for example, a removable medium 421 in FIG. 16) according to an embodiment of the present invention is a program for image processing for an image processing apparatus (for example, a digital video camera 71 in FIG. 1), which includes a determining step (for example, steps S51, S52 and S54 in FIG. 7) of determining a relationship between a first aspect ratio which is an aspect ratio of a source image of a thumbnail image and a second aspect ratio which is an aspect ratio of a display screen on which the thumbnail image is to be displayed, a reduction step (for example, steps S53 and S55 in FIG. 7) of reducing, where the first and second aspect ratios are different from each other, the height or the width of the thumbnail image, and an outputting step (for example, a step S56 in FIG. 7) of outputting the thumbnail image of the reduced height or width.

A program according to an embodiment of the present invention is a program for causing a computer of an image processing apparatus (for example, a digital video camera 71 in FIG. 1) to execute image processing, which includes a determining step (for example, steps S51, S52 and S54 in FIG. 7) of determining a relationship between a first aspect ratio which is an aspect ratio of a source image of a thumbnail image and a second aspect ratio which is an aspect ratio of a display screen on which the thumbnail image is to be displayed a reduction step (for example, steps S53 and S55 in FIG. 7) of reducing, where the first and second aspect ratios are different from each other, the height or the width of the thumbnail image, and an outputting step (for example, a step S56 in FIG. 7) of outputting the thumbnail image of the reduced height or width.

In the following, an embodiment of the present invention is described with reference to the drawings.

FIG. 1 is a perspective view showing an example of a configuration of a display control system to which the present invention is applied.

The display control system includes a digital video camera 71 and a TV receiver 72. As shown in FIG. 1, the digital video camera 71 and the TV receiver 72 are connected to each other.

The digital video camera 71 includes an image pickup section 81 to which light is inputted from a subject not shown and includes a lens, a restrictor, a CCD (Charge Coupled Device) sensor and so forth, and a viewfinder 82 for displaying an image of the subject being captured to cause the user to confirm the image. The digital video camera 71 further includes a display section 83 for displaying an image of a subject, a power supply switch 84 for being operated in order to switch the power supply to the digital video camera 71 on or off, and a changeover switch 85 for being operated in order to change over the mode of the digital video camera 71 to an image reproduction mode, an image pickup mode or the like.

The display section 83 is formed, for example, from an LCD (Liquid Crystal Display) unit or the like. The display section 83 is mounted for opening and closing pivotal motion on a main body 71A of the digital video camera 71 through a hinge section not shown. The display section 83 displays an image being picked up or an image reproduced from a recording medium on a display screen 91. A battery 86 is attached to the rear side of the main body 71A. Further, a band 87 is attached to a right side face of the main body 71A.

The digital video camera 71 can pick up not only moving pictures but also still pictures.

The digital video camera 71 displays one or plural thumbnail images as a list of images recorded already on the viewfinder 82 or the display screen 91. Further, the digital video camera 71 supplies an image being picked up, a reproduction image from a recording medium, or a thumbnail image to the TV receiver 72 so as to be displayed on the TV receiver 72.

It is to be noted that a thumbnail image is an image coordinated with (data of) an image which is an object of a desired process such as reproduction, deletion or editing and having a display size smaller than that of the source image. For example, where the source image is a still picture, a thumbnail image of the source image has a display size reduced from the display size of the source still picture. On the other hand, where the source image is a moving picture, a thumbnail image of the source image is formed as an image formed by reducing the size of an image designated manually or automatically from among the moving pictures from the display size of the source image.

The display section 92 of the TV receiver 72 may be formed from a CRT (Cathode Ray Tube), an LCD unit or the like. The TV receiver 72 displays an image corresponding to image data outputted from the digital video camera 71 on the display screen 92.

Further, the digital video camera 71 can display a thumbnail image simultaneously on the viewfinder 82 and the display screen 91. The thumbnail image can be displayed also on the display screen 92.

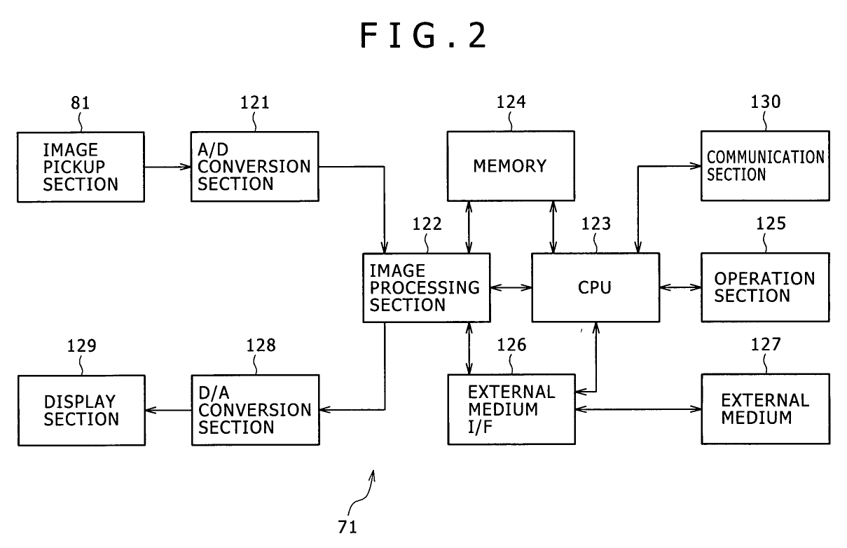

FIG. 2 shows an example of an internal configuration of the digital video camera 71. Referring to FIG. 2, the digital video camera 71 includes an image pickup section 81, an A/D (Analog-to-Digital) conversion section 121, an image processing section 122, a CPU (Central Processing Unit) 123, a memory 124, and an operation section 125. The digital video camera 71 further includes an external media interface (hereinafter referred to as external media I/F) 126, a D/A (Digital-to-Analog) conversion section 128, a display section 129, and a communication section 130. An external medium 127 is loaded into the external media I/F 126 as occasion demands.

The image pickup section 81 supplies an image signal corresponding to an image of a subject being picked up to the A/D conversion section 121. The A/D conversion section 121 converts the image signal in the form of an analog signal supplied thereto from the image pickup section 81 into a digital signal and supplies the digital signal to the image processing section 122.

The image processing section 122 is formed from a DSP (Digital Signal Processor) or the like. The image processing section 122 produces control signals such as an AF (Auto Focus) control signal, an AE (Auto Exposure) control signal and an AWB (Auto White Balance) control signal based on signals inputted thereto and supplies the control signals to the CPU 123. Further, the image processing section 122 performs encoding (compression) and decoding (decompression) for an image signal supplied thereto from the A/D conversion section 121.

Image data compressed by the image processing section 122 are supplied to and recorded on the external medium 127 through the memory 124 formed from a flash memory or the like and the external media I/F 126.

The CPU 123 executes various processes in accordance with a program stored in the memory 124. Data necessary for the CPU 123 to execute various processes and so forth are suitably stored in the memory 124. The CPU 123 controls operation of the entire digital video camera 71.

The operation section 125 includes a power supply switch 84, a changeover switch 85, various buttons including a menu button not shown, dials for setting an exposure value, a shutter speed, zooming, focusing and so forth, knobs and the like elements. The operation section 125 accepts various operations performed by the user and supplies information of the various operations to the CPU 123. The CPU 123 executes various processes based on the operation information.

The external media I/F 126 is formed, for example, from a drive or the like. The external medium 127 is loaded into the external media I/F 126.

The external medium 127 is formed, for example, from a DVD which is an optical disk having a great capacity or a like medium. The DVD used as the external medium 127 is an example of a recording medium, but any recording medium may be used only if data can be recorded on and reproduced from the same through chemical or physical variation.

Image data of an image being picked up by the image pickup section 81 or an image reproduced from the external medium 127 is supplied to the D/A conversion section 128 through the image processing section 122. The D/A conversion section 128 converts the image data supplied thereto in the form of a digital signal into an analog signal and supplies the analog signal to the display section 129.

The display section 129 may be formed from the viewfinder 82 or the display section 83 shown in FIG. 1. The display section 129 displays an image corresponding to image data supplied thereto from the D/A conversion section 128. In particular, the viewfinder 82 or the display section 83 displays an image corresponding to image data supplied thereto from the D/A conversion section 128.

Further, the CPU 123 outputs image data corresponding to a plurality of thumbnail images which indicate as a list of an image being picked up, images reproduced from the external medium 127 and images recorded on the external medium 127 to the TV receiver 72 through the communication section 130 which may be formed from a connector or the like. Further, the CPU 123 acquires various pieces of information such as the aspect ratio of the display screen 92 of the TV receiver 72 through the communication section 130.

The image processing section 122 expands a moving picture whose aspect ratio is 16:9 in a vertical direction to adjust the ratio in dimension between the width and the height of the image (number of pixels) to 4:3 and records the resulting image on the external medium 127 (in accordance with a squeezing method). A moving picture whose aspect ratio is 4:3 is recorded without undergoing the changing process of the aspect ratio.

Further, the image processing section 122 edits an image of a frame designated by the user or an image of a frame selected and designated by the image processing section 122 based on a predetermined rule as a thumbnail image and records the resulting image on the external medium 127.

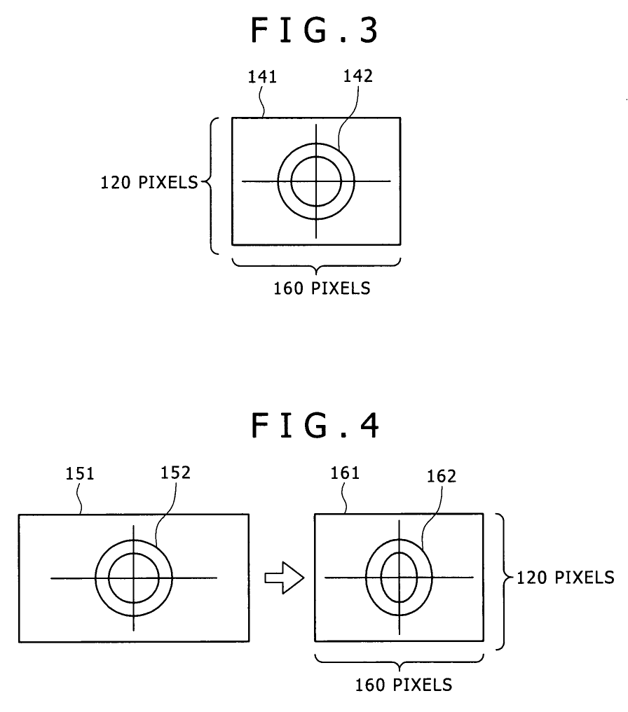

As regards a thumbnail image, it is prescribed in the Exif (Exchangeable Image file Format) in the DCF (Design rule for Camera File System) that the image size is 160 pixels (horizontal width)×120 pixels (vertical height) as seen in FIG. 3. Accordingly, a thumbnail image of an image whose aspect ratio is 4:3 is produced by reducing the entire image as it is as seen in FIG. 3.

In contrast, as regards a still picture which is to be recorded with the aspect ratio of 16:9, a thumbnail image is formed by reducing the source image in a widthwise or horizontal direction to adjust the ratio in dimension between the width and the height to 4:3 in order to effectively utilize the region of 160 pixels×120 pixels as seen in FIG. 4.

FIG. 5 illustrates an example of a functional configuration of an image processing program 201 to be executed by the CPU 123. The image processing program 201 includes an image acquisition section 211, an aspect ratio detection section 212, a determining section 213, a reduction section 214, and a drawing section 215.

The image acquisition section 211 acquires (reads out) an image desired by the user from the external medium 127 and supplies the acquired image to the aspect ratio detection section 212.

The aspect ratio detection section 212 detects the aspect ratio or information corresponding to the aspect ratio from the image supplied from the image acquisition section 211, that is, a moving picture or a still picture. Further, the aspect ratio detection section 212 causes the memory 124 to store the detected information.

The determining section 213 detects the aspect ratio of a display screen on which an image is to be displayed such as, for example, the display screen 91 or the display screen 92 and acquires the aspect ratio of an image to be displayed from the memory 124. Further, the determining section 213 determines whether the aspect ratio of the display screen or the image is, for example, 4:3 or 16:9 and supplies a result of the determining to the reduction section 214.

The reduction section 214 reduces the size of a thumbnail image which is to be displayed on the display screen 91 or the display screen 92 and which corresponds to an image recorded on the external medium 127 to the predetermined size based on a result of the determining supplied from the determining section 213. The reduction section 214 supplies the reduced image to the drawing section 215.

The drawing section 215 draws the thumbnail image supplied from the reduction section 214 in a drawing region for an index image. Here, the index image is an image on which one or a plurality of thumbnail images are disposed. Further, the drawing region is a region in which a thumbnail image which forms the index image is to be drawn. The index image is displayed on the display section 129 or the TV receiver 72.

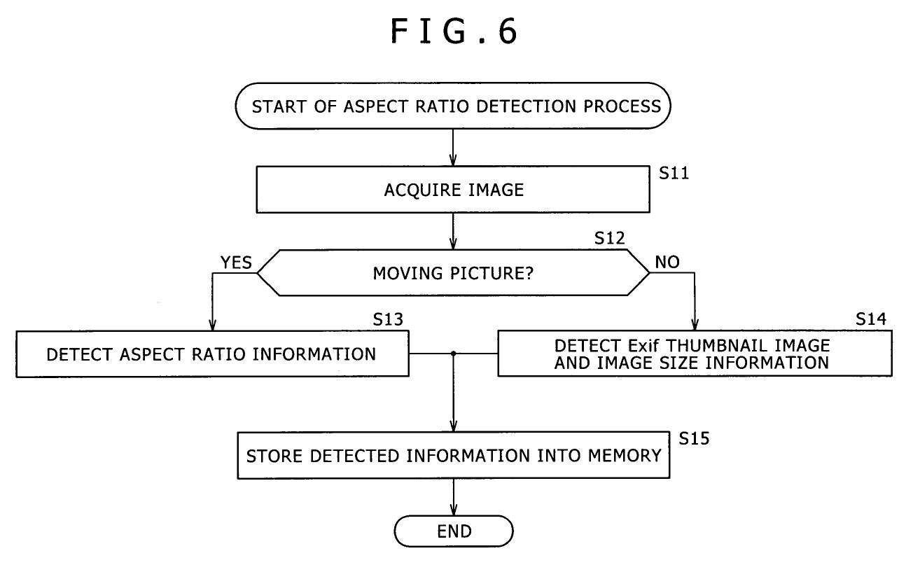

Now, an aspect ratio detection process executed by the CPU 123 which executes the image processing program 201 is described with reference to FIG. 6. The aspect ratio detection process is started when an instruction to display a thumbnail image on the display section 129 or the TV receiver 72 is inputted by an operation of the operation section 125 by the user. In particular, the aspect ratio detection process is started when an instruction to display a list of images recorded on the external medium 127 on the display section 129 or the TV receiver 72 is inputted.

At step S11, the image acquisition section 211 acquires (reads out) an image recorded on the external medium 127 from the external medium 127.

At step S12, the aspect ratio detection section 212 determines whether or not the image acquired by the process at step S11 is a moving picture. In particular, the aspect ratio detection section 212 determines, from an extension of the image data acquired from the external medium 127 or the like, whether the image is a moving picture (MPEG) or a still picture (JPEG) depending upon whether the image data are encoded (compressed) in accordance with the MPEG (Moving Picture Experts Group) system or with the JPEG (Joint Photographic Experts Group) system.

If it is determined at step S12 that the acquired image is a moving picture, the aspect ratio detection section 212 detects aspect ratio information included in the moving picture data at step S13. For example, where the external medium 127 is a DVD, the aspect ratio information recorded for each of chapters of moving pictures is detected based on management information recorded in the directory of the DVD. The aspect ratio information includes information of the aspect ratio of an image corresponding to each chapter from among images of frames of the moving pictures. The aspect ratio is used as an original aspect ratio of a thumbnail image of the moving pictures in processes at steps S52 and S54 in FIG. 7 hereinafter described.

After the process at step S13, the aspect ratio detection section 212 causes the memory 124 to store the detected aspect ratio information at step S15.

If it is determined at step S12 that the acquired image is not a moving picture, that is, if the image acquired in the process at step S11 is a still picture, then the aspect ratio detection section 212 detects an Exif thumbnail and image size information from Exif data included in the still picture data at step S14. The Exif thumbnail is a thumbnail image to be drawn in a drawing region in an index image drawing process of FIG. 7 hereinafter described. Meanwhile, the image size information is information of the size of a still picture and is used as an original aspect ratio of a thumbnail image of a still picture in processes at steps S52 and S54 of FIG. 7 hereinafter described.

After the process at step S14, the aspect ratio detection section 212 causes the memory 124 to store the Exif thumbnail and the image size information at step S15.

The processing is ended after the process at step S15.

The aspect ratio detection process described above is executed for all images recorded on the external medium 127.

Now, an index image drawing process by the CPU 123 by which the image processing program 201 is executed is described with reference to the flow chart of FIG. 7. The index image drawing process is started, for example, when the process described hereinabove with reference to the flow chart of FIG. 6 is executed for all images recorded on the external medium 127.

It is to be noted that, in the index image drawing process, an Exif thumbnail detected by the process at step S14 of FIG. 6 is used as a thumbnail image of a still picture. Meanwhile, a thumbnail image recorded in advance in the external medium 127 is used as a thumbnail image of a moving picture. Further, where a thumbnail image of moving pictures is not recorded in the external medium 127, a thumbnail image produced for each chapter of the moving pictures by reducing the size of a manually or automatically designated one of the moving pictures is used as a thumbnail image of the moving pictures.

It is to be noted that the digital video camera 71 displays a thumbnail image, for example, on the display screen 92 of the TV receiver 72.

First at step S51, the determining section 213 determines whether or not the aspect ratio of the display screen 92 is 4:3. The aspect ratio of the display screen 92 of the TV receiver 72 is set to the digital video camera 71 by the user operating the operation section 125. At this time, the aspect ratio of the display screen 92 is stored into the memory 124. The determining section 213 performs the process of determining at step S51 based on the stored information.

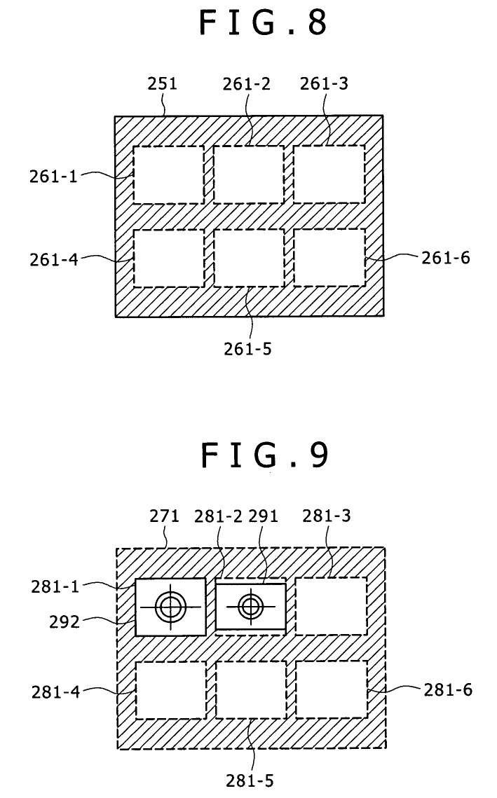

Here, an index image to be displayed on the display screen 92 in which thumbnail images are to be disposed is described with reference to FIG. 8.

The index image is an image in which an arbitrary number of thumbnail images are disposed at predetermined positions. In an example shown in FIG. 8, six thumbnail images form an index image, and therefore, drawing regions 261-1 to 261-6 which are regions in each of which a thumbnail image is to be drawn (displayed) are disposed in an index image 251. In this manner, an arbitrary number of thumbnails are displayed in combination as an index image.

The index image 251 and the drawing regions 261-1 to 261-6 have aspect ratios equal to the aspect ratio of the display screen 92 of an object of display. Accordingly, where the aspect ratio of the display screen 92 is 4:3, also the aspect ratio of the index image is 4:3.

In the following description, where there is no necessity to distinguish the drawing regions 261-1 to 261-6 from each other, any of the drawing regions 261-1 to 261-6 is referred to merely as drawing region 261.

It is to be noted that, although the six drawing regions 261-1 to 261-6 are disposed in the index image 251 of FIG. 8, the number of such drawing regions 261 is not limited to six but may be an arbitrary number.

If it is determined at step S51 of FIG. 7 that the aspect ratio of the display screen 92 is 4:3, then the determining section 213 determines at step S52 whether or not the original aspect ratio of the thumbnail image is 4:3. In particular, the determining section 213 determines, based on the aspect ratio information of moving pictures (for example, a flag representative of the aspect ratio of 16:9 or 4:3 of the chapter) or image size information of a still picture, stored in the memory 124 as a result of the process at step S15 of FIG. 6, whether or not the aspect ratio of the thumbnail image to be drawn in a drawing region 261 is 4:3. In other words, a relationship between the aspect ratio of the source image of the thumbnail image and the aspect ratio of the display screen is determined at steps S51 and S52.

If it is determined at step S52 that the original aspect ratio of the thumbnail image to be drawn in a drawing region 261 is not 4:3, that is, if the original aspect ratio of the thumbnail image is 16:9, then the reduction section 214 reduces the dimension (height) of the thumbnail image in the vertical direction to ¾.

In particular, a thumbnail image 151 whose aspect ratio is 16:9 is corrected into and recorded as a thumbnail image 161 of 160 pixels×120 pixels (the ratio in dimension between the width and the height on the external medium 127 as described hereinabove with reference to FIG. 4. The thumbnail image 161 whose aspect ratio is corrected from 16:9 to 4:3 in this manner is distorted such that a circle 162 is elongated vertically as seen in FIG. 4. The distorted circle 162 is derived from a circle 152 which is a genuine circle before the aspect ratio thereof is corrected. Accordingly, if the thumbnail image 161 of the source image whose aspect ratio is 16:9 is drawn as it is in a drawing region 261 whose aspect ratio is 4:3, then it is displayed as a thumbnail image distorted in a vertically elongated state on the display screen 92.

In order to prevent this, the reduction section 214 reduces the dimension in the vertical direction (height) of the thumbnail image stored in the memory 124 for an editing process to ¾ times.

In particular, it is assumed that index image data 271 corresponding to the index image 251 is stored in the buffer region for image display of the memory 124 as seen in FIG. 9. Drawing image data 281-1 to 281-6 correspond to the drawing regions 261-1 to 261-6, respectively.

For example, if thumbnail image data 291 of FIG. 9 is image data of a thumbnail image whose aspect ratio is corrected from 16:9 to 4:3, then the dimension in the vertical direction is reduced to ¾ times so that the resulting image has the original aspect ratio of 16:9.

After the process at step S53, the drawing section 215 draws, at step S56, the thumbnail image reduced by the process at step S53 in a corresponding drawing region 261. In particular, the index image data 271 shown in FIG. 9 whose aspect ratio is 4:3 is read out from the memory 124 and is outputted and displayed as an index image on the display screen 92 whose aspect ratio is 4:3.

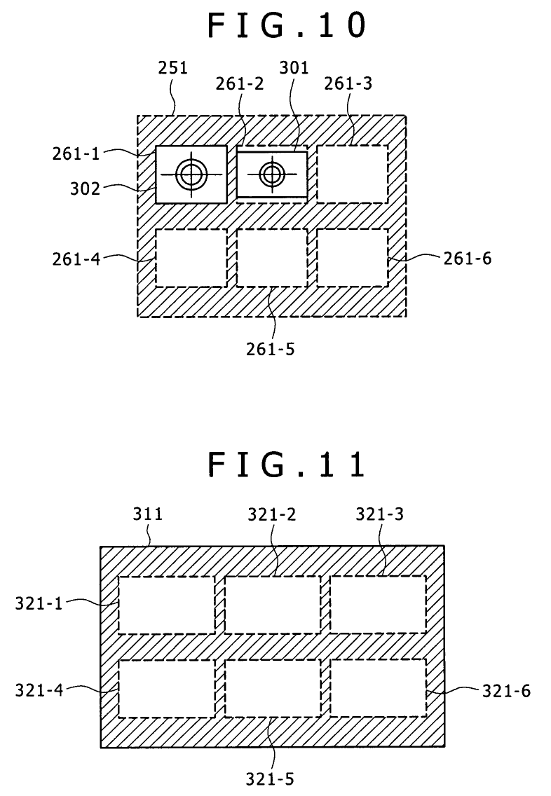

As a result of the process at step S56, a thumbnail image 301 corresponding to the thumbnail image data 291 is displayed, for example, in the drawing region 261-2 as shown in FIG. 10. This thumbnail image 301 is displayed as an image which is not distorted at all.

It is to be noted that a dark image or a pattern (image) same as the background (indicated by slanting lines) of the index image 251 is displayed at an upper end portion and a lower end portions (substantially no-image portions) of the drawing region 261-2 in FIG. 10.

If it is determined at step S52 that the aspect ratio of the source image of the thumbnail image is 4:3, then the process at step S53 is skipped, and the drawing section 215 draws the thumbnail in the drawing region 261 at step S56.

As seen in FIG. 3, a circle 142 of the thumbnail image 141 whose aspect ratio is not corrected and remains 4:3 is not distorted in the drawing region 261 whose aspect ratio is 4:3. Accordingly, the process at step S53 is not executed, but the thumbnail image is drawn as it is in the drawing region 261 at step S56. In particular, in the example of FIG. 9, thumbnail image data 292 corresponding to a thumbnail image whose aspect ratio is originally 4:3 and is not corrected is disposed in drawing region data 281-1 of the index image data 271 and is drawn (displayed) as a thumbnail image 302 corresponding to the thumbnail image data 292 in the drawing region 261-1 as seen in FIG. 10.

If it is determined at step S51 that the aspect ratio of the display screen 92 is not 4:3, that is, if the aspect ratio of the display screen 92 is 16:9, then the determining section 213 determines at step S54 whether or not the aspect ratio of the source image of the thumbnail image is 4:3. The process of determining at step S54 is executed similarly to the process of determining at step S52. Thus, a relationship between the aspect ratio of the source image of the thumbnail image and the aspect ratio of the display screen is determined at steps S51 and S54.

An example of an index image where the aspect ratio of the display screen 92 is 16:9 is shown in FIG. 11.

The index image has arbitrary thumbnail images disposed therein as described hereinabove. Drawing regions 321-1 to 321-6 in each of which a thumbnail image is to be drawn are disposed in the index image 311 of FIG. 11.

In the present case, since the aspect ratio of the display screen 92 is 16:9, also the aspect ratios of the index image 311 and the drawing regions 321-1 to 321-6 are 16:9.

In the following description, where there is no necessity to individually distinguish the drawing regions 321-1 to 321-6 from each other, each of them is referred to merely as drawing region 321.

It is to be noted that, although the six drawing regions 321-1 to 321-6 are disposed in the index image 311, the number of such drawing regions 321 is not limited to six but may be an arbitrary number.

If it is determined at step S54 that the aspect ratio of the source image of the thumbnail image is not 4:3, that is, if the aspect ratio of the source image of the thumbnail image is 16:9, then the drawing section 215 draws (outputs) the thumbnail image in the drawing region 321 at step S56.

FIG. 12 illustrates image data 331 corresponding to the index image 311 of FIG. 11. Referring to FIG. 12, the index image data 331 is stored in a buffer region for image display of the memory 124. Further, drawing region data 341-1 to 341-6 correspond to the drawing regions 321-1 to 321-6, respectively.

It is to be noted that the drawing region data 341-1 to 341-6 have an aspect ratio of 4:3. This is because it is prescribed by the Exif standards that a thumbnail image of a digital video camera 71 be recorded as an image of 160 pixels×120 pixels.

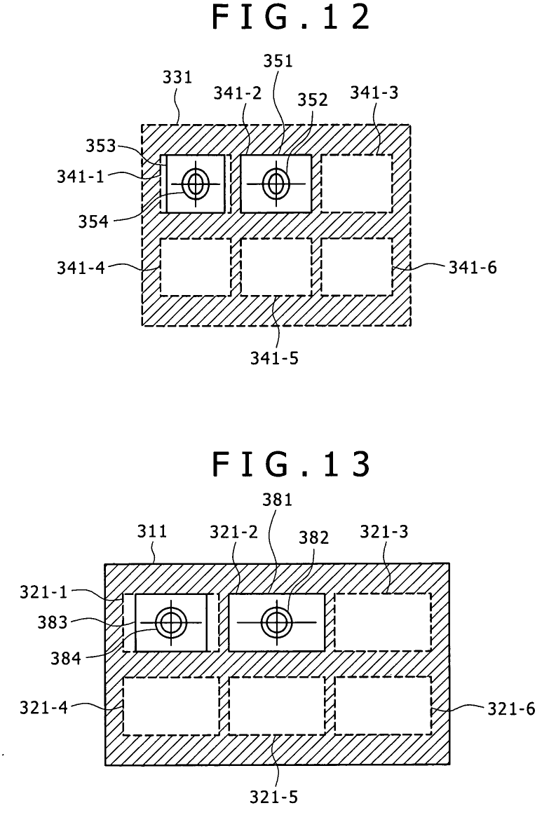

As seen in FIG. 4, a thumbnail image whose aspect ratio is 16:9 is stored as a thumbnail image whose aspect ratio is 4:3 with the width thereof reduced to ¾. As seen in FIG. 12, thumbnail image data 351 which corresponds to the thumbnail image whose aspect ratio is corrected from 16:9 to 4:3 is disposed as it is in the drawing region data 341-2 of the index image data 331. As seen in FIG. 13, a thumbnail image 381 corresponding to the thumbnail image data 351 is drawn (outputted) in the drawing region 321-2.

The TV receiver 72 has a function of displaying an image inputted thereto such that left and right end portions of horizontal scanning lines of the inputted image are positioned at left and right end portions of the screen in synchronism with a horizontal synchronizing signal. Consequently, an image whose aspect ratio is 4:3 is elongated to 4/3 times in the horizontal or widthwise direction. As a result, the TV receiver 72 has a function of displaying an image whose aspect ratio is 4:3 as an image whose aspect ratio is 16:9. A circle 352 shown in FIG. 12 is displayed without being distorted (as a genuine circle) like a circle 382 shown in FIG. 13.

Alternatively, the digital video camera 71 may issue an instruction signal to the TV receiver 72 to expand the index image corresponding to the index image data 331 so that the aspect ratio may become 16:9.

On the other hand, if it is determined at step S54 of FIG. 7 that the aspect ratio of the original image of the thumbnail image is 4:3 (the aspect ratio the thumbnail image is not corrected), then the reduction section 214 reduces the width of the thumbnail image in the widthwise direction to ¾ at step S55.

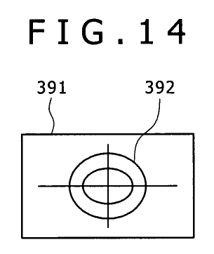

In particular, a thumbnail image whose original aspect ratio is 4:3 is recorded as an image of 160 pixels×120 pixels (the ratio in dimension between the width and the height is 4:3) (an image whose aspect ratio is not corrected) on the external medium 127 as described hereinabove with reference to FIG. 3. Therefore, if a thumbnail image of a source image whose aspect ratio is 4:3 is drawn as it is in drawing region data 341 whose aspect ratio is 4:3, then the image is expanded such that the ratio in dimension between the width and the height of the image becomes 16:9 on the display screen 92. Therefore, for example, a circle 392 as a thumbnail image 391 is displayed on the display screen 92 such that it is distorted in a state elongated in a widthwise direction as seen in FIG. 14.

In order to prevent this, the reduction section 214 reduces the dimension (width) in the widthwise direction of the thumbnail image to ¾ times, the thumbnail image being stored in the memory 124 for editing and whose aspect ratio is not corrected. As a result, the width of thumbnail image data 353 whose aspect ratio is corrected is reduced to ¾ and a circle 354 is elongated in the vertical direction as seen in FIG. 12.

However, if the drawing section 215 draws a thumbnail image 383 corresponding to the thumbnail image data 353 in the drawing region 321 at step S56, then the TV receiver 72 displays the image so that the aspect ratio thereof may be 16:9. Since the thumbnail image data 353 is elongated in the horizontal direction, the circle 354 in FIG. 12 becomes a circle 384 shown in FIG. 13 and is displayed without being distorted (as a genuine circle).

It is to be noted that a dark image or a pattern (image) same as the background (indicated by slanting lines) of the index image 311 is displayed at a left end portion and a right end portions of the drawing region 321-2 in FIG. 13.

The process described above is executed repetitively until all thumbnail images are displayed in the drawing regions 261 of the index image 251 or the drawing regions 321 of the index image 311.

In the foregoing description, the index image drawing process of FIG. 7 is executed after the aspect ratio detection process of FIG. 6 is executed for all images recorded on the external medium 127. However, alternatively the aspect ratio detection process of FIG. 6 and the index image drawing process of FIG. 7 may be executed for each of the images recorded on the external medium 127.

In this manner, where images whose aspect ratio is 4:3 and images whose aspect ratio is 16:9 are recorded in a mixed state as still pictures or moving pictures on the external medium 127, thumbnail images derived from the recorded images can be displayed with minimized distortion on one display screen, for example, on the display screen 91 or the display screen 92.

Further, where the aspect ratio of an image and the aspect ratio of the display screen are equal to each other, drawing regions can be utilized wastelessly. Consequently, the utilization efficiency of the display screen is enhanced.

Since the squeezing method or an algorithm common to that of the squeezing method can be utilized for the process of converting the aspect ratio from 16:9 to 4:3, the process can be simplified.

It is to be noted that the digital video camera 71 may determine based on information of a terminal of the TV receiver 72 connected thereto whether or not the TV receiver 72 is an HDTV (High-Definition Television) receiver. Where the TV receiver 72 is an HDTV receiver, the aspect ratio of the display screen 92 is 16:9. At this time, the digital video camera 71 performs the processes only at steps S54 to S56 in the index image drawing process of FIG. 7.

In this instance, thumbnail images can be displayed more rapidly on the TV receiver 72.

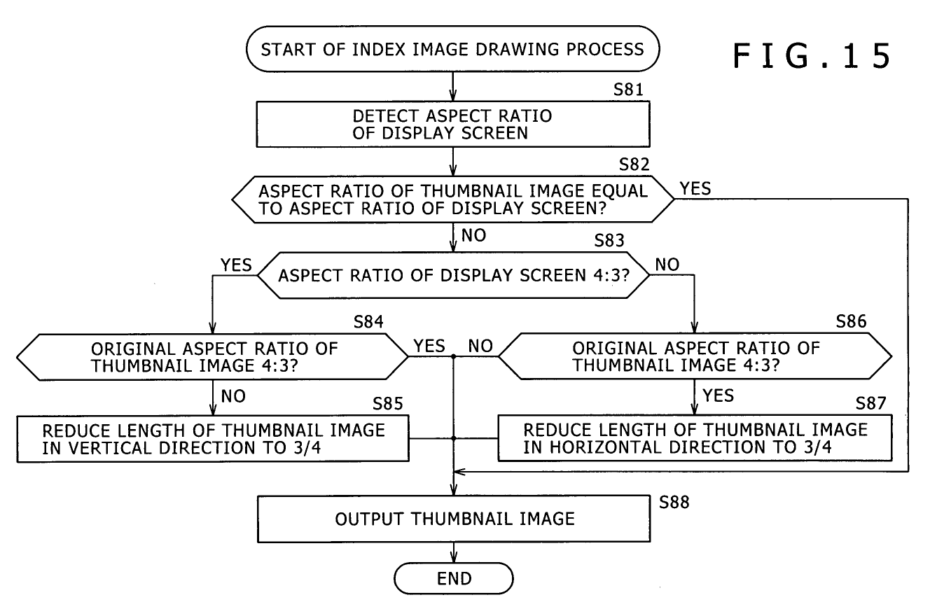

Now, another example of the index image drawing process of FIG. 7 is described with reference to a flow chart of FIG. 15.

At step S81, the determining section 213 detects the aspect ratio of the display screen 92. For example, upon connection between the digital video camera 71 and the TV receiver 72, the aspect ratio detection section 212 detects information of the aspect ratio of the display screen 92 of the TV receiver 72 based on information of terminals of the TV receiver 72 and stores the detected information of the aspect ratio into the memory 124. The determining section 213 performs the determining process at step S82 based on the stored information. Further, where a thumbnail image is to be displayed on the viewfinder 82 or the display screen 91, the determining section 213 detects the aspect ratio of the viewfinder 82 or the display screen 91 stored in the memory 124 and performs the determining process at step S82 based on the detected aspect ratio.

At step S82, the determining section 213 determines whether or not the aspect ratio of a thumbnail image is equal to the aspect ratio of the display screen 92. In particular, the determining section 213 performs the determining process at step S82 based on the aspect ratio information of moving pictures or image size information of a still picture stored in the memory 124 as a result of the process at step S15 of FIG. 6.

If it is determined at step S82 that the aspect ratio of a thumbnail image is not equal to the aspect ratio of the display screen 92, then the processing advances to step S83. On the other hand, if it is determined at step S82 that the aspect ratio of a thumbnail image is equal to the aspect ratio of the display screen 92, then the drawing section 215 draws a thumbnail image in a corresponding drawing region of the index image at step S88. In particular, index image data is read out from the memory 124 and outputted and displayed as an index image to and on the display screen 92.

At steps S83 to S88, processes similar to those at steps S51 to S56 of FIG. 7 are executed, respectively, and overlapping description of the processes is omitted herein to avoid redundancy.

As a result of the process described above, the user need not set the aspect ratio of the display screen 92 of the TV receiver 72 to the digital video camera 71 in advance, and can readily cause the display screen 92 to display thumbnail images.

The image processing apparatus according to the present invention is not limited to the digital video camera 71 but can be applied to image processing apparatus which can at least record and read out an image on and from a recording medium such as digital still cameras, PDAs (Personal Digital Assistants) and portable telephone sets. In particular, the image processing apparatus according to the present invention can be applied, for example, to personal computers.

FIG. 16 shows an example of a configuration of such a personal computer 401 as just mentioned. Referring to FIG. 16, a CPU 411 executes various processes in accordance with a program stored in a ROM (Read Only Memory) 412 or a program loaded from a storage section 419 into a RAM (Random Access Memory) 413. Also data and so forth necessary for the CPU 411 to execute the processes are suitably stored into the RAM 413.

The CPU 411, ROM 412 and RAM 413 are connected to one another by a bus 414. Also an input/output interface 415 is connected to the bus 414.

An inputting section 416 including a keyboard, a mouse and so forth, an outputting section 417 including a display unit which may be a CRT or an LCD unit, and a speaker and so forth, a storage section 419 formed from a hard disk or the like, a communication section 418 including a modem, a terminal adapter and so forth are connected to the input/output interface 415. The communication section 418 performs a communication process with another apparatus through a LAN (Local Area Network) or the Internet.

Further, a drive 420 is connected to the input/output interface 415. A removable medium 421 such as a magnetic disk, an optical disk, a magneto-optical disk, a semiconductor memory or the like is suitably loaded into the drive 420, and a computer program read from the loaded removable medium 421 is installed into the storage section 419 as occasion demands.

In the personal computer 401, the processes described above are executed by software.

Where the series of processes described hereinabove is executed by software, a program which constructs the software is installed from a recording medium into a computer incorporated in hardware for exclusive use or, for example, a personal computer for universal use which can execute various functions by installing various programs.

The recording medium is formed as a package medium which is distributed to provide the program to a user separately from a computer and may be a magnetic disk (including a floppy disk), an optical disk (including a CD-ROM (Compact Disk Read-Only Memory) and a DVD), or a magneto-optical disk (including an MD (Mini Disc) (trademark)), or a semiconductor memory which has the program recorded thereon or therein like the removable medium 421 shown in FIG. 16. Else, the recording medium may be formed as the ROM 412, the storage section 419 which may include a hard disk or the like in which the program is recorded and which is distributed to a user in a state wherein the program is incorporated in a computer.

It is to be noted that the program described hereinabove for causing the series of processes to be executed may be installed into a computer through an interface such as a router or a modem and through a wired or wireless medium such as a local area network, the Internet or a digital satellite broadcasting system.

Further, in the present specification, the steps which describe the program recorded in a recording medium may be but need not necessarily be processed in a time series in the order as described, and include processes which are executed in parallel or individually without being processed in a time series.

Further, in the present specification, the term “system” is used to represent an entire apparatus composed of a plurality of devices or apparatus.

While a preferred embodiment of the present invention has been described using specific terms, such description is for illustrative purpose only, and it is to be understood that changes and variations may be made without departing from the spirit or scope of the following claims.

What is claimed is:

1. An image processing apparatus, comprising:
determining means for determining a relationship between a first aspect ratio which is an aspect ratio of a source image of a thumbnail image and a second aspect ratio which is an aspect ratio of a display screen on which the thumbnail image is to be displayed;
reduction means for reducing, where the first and second aspect ratios are different from each other, the height or the width of the thumbnail image; and
outputting means for outputting the thumbnail image of the reduced height or width.

2. The image processing apparatus according to claim 1, wherein, where the first aspect ratio is 16:9 and the second aspect ratio is 4:3, said reduction means reduces the height of the thumbnail image to ¾.

3. The image processing apparatus according to claim 1, wherein, where the first aspect ratio is 4:3 and the second aspect ratio is 16:9, said reduction means reduces the width of the thumbnail image to ¾.

4. An image processing method for an image processing apparatus, comprising the steps of:
determining a relationship between a first aspect ratio which is an aspect ratio of a source image of a thumbnail image and a second aspect ratio which is an aspect ratio of a display screen on which the thumbnail image is to be displayed;
reducing, where the first and second aspect ratios are different from each other, the height or the width of the thumbnail image; and
outputting the thumbnail image of the reduced height or width.

5. A recording medium on or in which a computer-readable program for image processing for an image processing apparatus is recorded, the program comprising the steps of:
determining a relationship between a first aspect ratio which is an aspect ratio of a source image of a thumbnail image and a second aspect ratio which is an aspect ratio of a display screen on which the thumbnail image is to be displayed;
reducing, where the first and second aspect ratios are different from each other, the height or the width of the thumbnail image; and
outputting the thumbnail image of the reduced height or width.

6. A program for causing a computer of an image processing apparatus to execute image processing, said program comprising the steps of:
determining a relationship between a first aspect ratio which is an aspect ratio of a source image of a thumbnail image and a second aspect ratio which is an aspect ratio of a display screen on which the thumbnail image is to be displayed;
reducing, where the first and second aspect ratios are different from each other, the height or the width of the thumbnail image; and
outputting the thumbnail image of the reduced height or width.

7. An image processing apparatus, comprising:
a determining section for determining a relationship between a first aspect ratio which is an aspect ratio of a source image of a thumbnail image and a second aspect ratio which is an aspect ratio of a display screen on which the thumbnail image is to be displayed;
a reduction section for reducing, where the first and second aspect ratios are different from each other, the height or the width of the thumbnail image; and
an outputting section for outputting the thumbnail image of the reduced height or width.
